(19) United States
(12) Patent Application Publication
(10) Pub. No.: US 2001/0006995 A1
(43) Pub. Date: Jul. 5, 2001

(54) Rubber mixtures based on uncrosslinked rubbers and crosslinked rubber particles as well as multifunctional isocyanates

(76) Inventors: Werner Obrecht, Moers (DE); Martin Mezger, Burscheid (DE)

Correspondence Address: BAYER CORPORATION, PATENT DEPARTMENT, 100 BAYER ROAD, PITTSBURGH, PA, 15205, US

(21) Appl. No.: 09/739,034

(22) Filed: Dec. 14, 2000

(30) Foreign Application Priority Data
Dec. 24, 1999 (DE) 19962862.9

(51) Int. Cl. C08L 75/00; C08F 8/30

(52) U.S. Cl. 525/123; 525/125

(57) ABSTRACT

The rubber mixtures according to the invention, containing uncrosslinked, double-bond-containing rubbers (A), crosslinked rubber particles (B) and multifunctional isocyanates (C), wherein the amount of component (B) in the mixture is from 1 to 150 parts by weight and the amount of multifunctional isocyanates (component C) is from 1 to 100 parts by weight, in each case based on 100 parts by weight (phr) of the rubber component (A), may be used in the production of rubber vulcanates and molded rubber bodies of any kind, the vulcanates produced therefrom having an advantageous combination of mechanical properties, such as tensile stress at 300% elongation, ultimate elongation, tear resistance and abrasion resistance.

### FIELD OF THE INVENTION

The present invention relates to rubber mixtures based on uncrosslinked rubbers and crosslinked rubber particles (so-called rubber gels) as well as multifunctional isocyanates. The rubber mixtures according to the present invention are suitable for the production of rubber vulcanates which have an advantageous combination of mechanical properties, such as tensile stress at 300% elongation, ultimate elongation, tear resistance and abrasion resistance. Furthermore, the vulcanates produced from the rubber mixtures according to the present invention have a lower density, which has an advantageous effect on the weight of the molded rubber bodies, especially tires or tire parts, produced from the vulcanates.

### BACKGROUND OF THE INVENTION

It is known that when rubber mixtures containing uncrosslinked rubbers and crosslinked rubber particles (rubber gels) as fillers are vulcanized with conventional vulcanizing agents (e.g. sulfur vulcanization), they yield vulcanates which produce low rebound resilience at room temperature (good wet-skid behavior) and high rebound resilience at 70° C. (low rolling resistance).

Reference is made in this connection to, for example, U.S. Pat. No. 5,124,408, U.S. Pat. No. 5,395,891, DE-A 197 01 488.7, DE-A 197 01 487.9, DE-A 199 29 347.3, DE-A 199 39 865.8, DE-A 199 42 620.1.

For commercial use, the reinforcing action of the microgels in vulcanates (tensile stress at 300% elongation -S₃₀₀-, ultimate elongation -D-, tear resistance and abrasion) is inadequate. This is shown especially by the fact that large amounts of gel must be used in order to achieve commercially relevant S₃₀₀ values. Such large amounts of gel lead to overfilling of the mixtures, as a result of which the resistance to tearing and the ultimate elongation of the vulcanates fall. It is, therefore, necessary from a commercial point of view to find measures for increasing the tensile stress of low-fill gel-containing rubber vulcanates. Moreover, it is necessary from a commercial point of view to reduce the DIN abrasion.

It is also known to vulcanize natural rubber containing carbon black as the filler with diisocyanates. However, the vulcanates obtained in that manner do not have satisfactory mechanical properties; moreover, the vulcanates adhere very greatly to the metal parts of the vulcanizing molds that are used (O. Bayer, Angewandte Chemie, Edition A, Volume 59, No. 9, p. 257-288, September 1947).

The object was to provide rubber mixtures that allow the production of vulcanates having improved mechanical properties (product of tensile stress at 300% elongation and ultimate elongation) as well as a low vulcanate density, which is desirable, for example, in the case of tires or individual tire components.

### SUMMARY OF THE INVENTION

Accordingly, the present invention provides rubber mixtures containing uncrosslinked, double-bond-containing rubbers (A), crosslinked rubber particles (B) and multifunctional isocyanates (C), wherein the amount of component (B) in the mixture is from 1 to 150 parts by weight and the amount of multifunctional isocyanates (component C) is from 1 to 100 parts by weight, in each case based on 100 parts by weight (phr) of the rubber component (A).

### DETAILED DESCRIPTION OF THE INVENTION

Preferred rubber mixtures according to the present invention are those which contain from 5 to 100 parts by weight of crosslinked rubber particles (component B) and from 3 to 50 parts by weight of multifunctional isocyanates (component C), in each case based on 100 parts by weight of the rubber component (A).

Double-bond-containing rubbers are to be understood as being those rubbers that are designated R rubbers according to DIN/ISO 1629. Those rubbers have a double bond in the main chain. They include, for example:

| | |
|---|---|
| NR: | natural rubber |
| SBR: | styrene/butadiene rubber |
| BR: | polybutadiene rubber |
| NBR: | nitrile rubber |
| JIR: | butyl rubber |
| BIIR: | brominated isobutylene/isoprene copolymers having |
| | bromine contents of from 0.1 to 10 wt. % |
| CIIR: | chlorinated isobutylene/isoprene copolymers having |
| | chlorine contents of from 0.1 to 10 wt. % |
| HNBR: | hydrogenated or partially hydrogenated nitrile rubber |
| SNBR: | styrene/butadiene/acrylonitrile rubber |
| CR: | polychioroprene |
| ENR: | epoxidized natural rubber or mixtures thereof |
| X-NBR: | carboxylated nitrile rubbers |
| X-SBR: | carboxylated styrene/butadiene copolymers. |

However, double-bond-containing rubbers are also to be understood as being those rubbers which are designated M rubbers according to DIN/ISO 1629 and which have double bonds in the side chain in addition to the saturated main chain. They include, for example, EPDM.

The double-bond-containing rubbers of the above-mentioned type to be used in the rubber mixtures according to the present invention may, of course, be modified by functional groups that are capable of reacting with the functional isocyanates that are to be used and, as will be described herein below, are able to improve coupling of the crosslinked rubber particles to the surrounding rubber matrix in the vulcanized state.

Special preference is given to those uncrosslinked rubbers which have been functionalized by hydroxyl, carboxyl, amino and/or amide groups.

The introduction of functional groups may take place directly during the polymerization by copolymerization with suitable comonomers, or after the polymerization by polymer modification.

The introduction of such functional groups by polymer modification is known and is described, for example, in M. L. Hallensleben “Chemisch modifizierte Polymere” in Houben-Weyl Methoden der Organischen Chemie, 4th edition, “Makromolekulare Stoffe” Part 1-3; Georg Thieme Verlag Stuttgart, New York, 1987; p. 1994-2042, DE-A 2 653 144, EP-A 464 478, EPA 806 452 and German Patent Application No. 198 32 459.6.

The amount of functional groups in the rubbers is usually from 0.05 to 2.5 wt. %, preferably from 0.1 to 10 wt. %.

The crosslinked rubber particles, so-called rubber gels, used in the mixtures according to the present invention are especially those which have been obtained by crosslinking of the following rubbers:

| | |
|---|---|
| BR: | polybutadiene |
| ABR: | butadiene/acrylic acid C₁₋₄-alkyI ester copolymers |
| IR: | polyisoprene |
| SBR: | styrene/butadiene copolymers having styrene contents of |
| | from 1 to 60 wt. %, preferably from 5 to 50 wt. % |
| X-SBR: | carboxylated styrene/butadiene copolymers |
| FKM: | fluorine rubber |
| ACM: | acrylate rubber |
| NBR: | polybutadiene/acrylonitrile copolymers having |
| | acrylonitrile contents of from 5 to 60 wt. %, |
| | preferably from 10 to 50 wt. % |
| X-NIBR: | carboxylated nitrile rubbers |
| CR: | polychioroprene |
| IIR: | isobutylene/isoprene copolymers having isoprene |
| | contents of from 0.5 to 10 wt. % |
| BIIR: | brominated isobutylene/isoprene copolymers having |
| | bromine contents of from 0.1 to 10 wt. % |
| CuR: | chlorinated isobutylene/isoprene copolymers having |
| | chlorine contents of from 0.1 to 10 wt. % |
| LINBR: | partially and completely hydrogenated nitrile rubbers |
| EPDM: | ethylene/propylene/diene copolymers |
| EAM: | ethylene/acrylate copolymers |
| EVM: | ethylene/vinyl acetate copolymers |
| CO and ECO: | epichlorohydrin rubbers |
| | silicone rubbers |
| AU: | polyester urethane polymers |
| EU: | polyether urethane polymers. |

The rubber particles to be used according to the present invention usually have particle diameters of from 5 to 1000 nm, preferably from 10 to 600 nm (diameter data according to DIN 53 206). Due to their crosslinking, such rubber particles are insoluble and swellable in suitable precipitating agents, for example toluene. The swelling indices of the rubber particles (Q₁) in toluene are approximately from 1 to 15, preferably from 1 to 10. The swelling index is calculated from the weight of the solvent-containing gel (after centrifugation at 20,000 rpm) and the weight of the dry gel, where Qᵢ=wet weight of the gel/dry weight of the gel. The gel content of the rubber particles according to the present invention is usually from 80 to 100 wt. %, preferably from 90 to 100 wt. %.

The preparation of the crosslinked rubber particles (rubber gels) that are to be used from the underlying rubbers of the above-mentioned type is known in principle and is described, for example, in U.S. Pat. No. 5,395,891 and EP-A 981 000 49.0.

In addition, it is possible to increase the particle sizes of the rubber particles by agglomeration. The preparation of silica/rubber hybrid gels by coagglomeration is also described, for example, in German Patent Application No. 199 39 865.8.

Of course, the crosslinked rubber particles, like the uncrosslinked double-bond-containing rubbers mentioned above, may likewise be modified by suitable functional groups which, as mentioned above, are capable of reacting with the multifunctional isocyanates that are to be used and/or bring about an improvement in the coupling of the rubber particles to the surrounding rubber matrix in the vulcanized state.

Hydroxyl, carboxyl, amino and/or amide groups may again be mentioned as preferred functional groups. The amount of those functional groups corresponds to the amount of those groups in the above-mentioned uncrosslinked, double-bond-containing rubbers.

The modification of the crosslinked rubber particles (rubber gels) and the introduction of the above-mentioned functional groups are likewise known to the person of ordinary skill in the art and are described, for example, in German Patent Applications Nos. 199 19 459.9, 199 29 347.3, 198 34 804.5.

Mention is to be made at this point only of the modification of the corresponding rubbers in aqueous dispersion with corresponding polar monomers which are capable of introducing a hydroxyl, amino, amide and/or carboxyl group into the rubbers.

Special preference is given to the use in the rubber mixtures according to the present invention of modified crosslinked rubber particles which have been modified at the surface by —OH; —COOH; —NH₂; —CONH₂; —CONHR groups and are present in the range of amounts mentioned above.

Multifunctional isocyanates (component C) which are suitable for the rubber mixtures according to the present invention, are those isocyanates having two or more, preferably 2, 3 and 4, isocyanate groups in the molecule, such as the known aliphatic, cycloaliphatic, aromatic, oligomeric and polymeric multifunctional isocyanates. An example of the aliphatic multifunctional isocyanates is hexamethylene diisocyanate (HDI); an example of the cycloaliphatic multifunctional isocyanates is 1-isocyanato-3-(isocyanatomethyl)-3, 5,5-trimethylcyclohexane (isophorone diisocyanate/IPDI). Examples of the aromatic multifunctional isocyanates are 2,4- and 2,6-diisocyanatotoluene as well as the corresponding technical isomeric mixture (TDI); diphenylmethane diisocyanates, such as diphenylmethane 4,4′-diisocyanate, diphenylmethane 2,4′-diisocyanate, diphenylmethane 2,2′-diisocyanate as well as the corresponding technical isomeric mixtures (MDI). Other examples are naphthalene 1,5-diisocyanate (NDI) and 4,4′,4″-triisocyanatotriphenylmethane.

In order to lower the vapor pressure and avoid a premature crosslinking reaction, for example during preparation of the mixture (reduction of the susceptibility of the mixtures to scorch), it may be necessary to use the multifunctional isocyanates in modified form. The most important modification variants are dimerization and trimerization as well as the reversible blocking, especially the temperature-reversible blocking (masking) of the isocyanate groups with specific alcohols, phenols, caprolactams, oximes or β-dicarbonyl compounds of the known type.

The rubber mixtures according to the present invention may contain further known rubber auxiliary substances and fillers. Especially preferred fillers for the production of the rubber mixtures or vulcanates according to the invention are, for example:

carbon blacks. The carbon blacks to be used in this connection are prepared according to the flame carbon black, furnace or gas carbon black process and have BET surface areas of from 20 to 200 m²/g, such as, for example, SAF, ISAF, IISAF, HAF, FEF or GPF carbon blacks.

highly dispersed silica, prepared, for example, by the precipitation of solutions of silicates or the flame hydrolysis of silicon halides having specific surface areas of from 5 to 1000 m²/g, preferably from 20 to 400 m²/g (BET surface area) and primary particle sizes of from 5 to 400 nm. The silicas may optionally also be present in the form of mixed oxides with other metal oxides, such as Al, Mg, Ca, Ba, Zn and Ti oxides.

synthetic silicates, such as aluminium silicate, alkaline earth metal silicate, such as magnesium silicate or calcium silicate, having BET surface areas of from 20 to 400 m²/g and primary particle diameters of from 5 to 400 nm.

natural silicates, such as kaolin and other naturally occurring silicas.

metal oxides, such as zinc oxide, calcium oxide, magnesium oxide, aluminium oxide.

metal carbonates, such as calcium carbonate, magnesium carbonate, zinc carbonate.

metal sulfates, such as calcium sulfate, barium sulfate.

metal hydroxides, such as aluminium hydroxide and magnesium hydroxide.

glass fibers and glass fibre products (laths, threads or glass microspheres).

thermoplastic fibers (polyamide, polyester, aramid).

The fillers may be used in amounts of from 0.1 to 100 parts by weight, based on 100 parts by weight of the rubber component A.

The mentioned fillers may be used on their own or in admixture with one another.

Special preference is given to rubber mixtures that contain from 10 to 100 parts by weight of crosslinked rubber particles (component B), from 0.1 to 100 parts by weight of carbon black and/or from 0.1 to 100 parts by weight of so-called light fillers of the above-mentioned type, in each case based on 100 parts by weight of the rubber component A. Where a mixture of carbon black and light fillers is used, the amount of fillers is not more than approximately 100 parts by weight.

The rubber mixtures according to the present invention may, as mentioned above, contain further rubber auxiliary substances, such as crosslinking agents, vulcanization accelerators, anti-aging agents, heat stabilizers, light stabilizers, antioxidants, processing auxiliaries, plasticizers, tackifiers, blowing agents, colorings, pigments, wax, extenders, organic acids, retarding agents, metal oxides, as well as filler activators, such as triethanolamine, polyethylene glycol, hexanetriol, bis-(triethoxysilyl-propyl) tetrasulfide. The rubber auxiliary substances are described, for example, in J. van Alphen, W. J. K. Schönbau, M. van Tempel Gummichemikalien, Berliner Union GmbH Stuttgart 1956 and in Handbuch für die Gummiindustrie, Bayer A G, 2nd edition, 1991.

The rubber auxiliary substances are used in conventional amounts, which are dependent inter alia on the intended use. Conventional amounts are, for example, from 0.1 to 50 parts by weight, based on 100 parts by weight of rubber (A).

The rubber mixtures according to the present invention may also contain conventional crosslinking agents, such as sulfur, sulfur donors, peroxides or other crosslinking agents, such as diisopropenylbenzene, divinylbenzene, divinyl ether, divinylsulfone, diallyl phthalate, triallyl cyanurate, triallyl isocyanurate, 1,2-polybutadiene, N,N′-m-phenylene maleimide and/or triallyl trimellitate. Other crosslinking agents may also include the acrylates and methacrylates of polyhydric, preferably di- to tetra-hydric, C₂- to C₁₀ alcohols, such as ethylene glycol, propanediol-1,2-butane-diol, hexanediol, polyethylene glycol having from 2 to 20, preferably from 2 to 8, oxyethylene units, neopentyl glycol, bisphenol A, glycerol, trimethylpropane, pentaerythritol, sorbitol with unsaturated polyesters of aliphatic diols and polyols as well as maleic acid, fumaric acid and/or itaconic acid.

Crosslinking agents such as sulfur and sulfur donors in the known amounts are preferably used, for example in amounts of from 0.1 to 10 parts by weight, preferably from 0.5 to 5 parts by weight, based on 100 parts by weight of rubber component (A).

The rubber mixtures according to the present invention may also contain vulcanization accelerators of the known type, such as mercapto-benzothiazoles, mercaptosulfenamides, guanidines, thiurams, dithiocarbamates, thioureas, thiocarbonates and/or dithiophosphates. The vulcanization accelerators, like the crosslinking agents, are used in amounts of approximately from 0.1 to 10 parts by weight, preferably from 0.1 to 5 parts by weight, based on 100 parts by weight of rubber component (A).

The rubber mixtures according to the present invention may be prepared in a known manner, for example by mixing the individual solid components in the apparatuses suitable for that purpose, such as rollers, kneaders or mixing extruders. Mixing of the individual components with one another is usually carried out at mixing temperatures of from 20 to 100° C.

The rubber mixtures according to the present invention may also be prepared from the latexes of the rubber component (A) component (B) in latex form and mixing the other components into the latex mixture (components A+B) and subsequently working up by conventional operations, such as concentration by evaporation, precipitation or freeze-coagulation.

The aim in the preparation of the rubber mixture according to the present invention is, above all, to mix the components of the mixture intimately with one another and to achieve good dispersion in the rubber matrix of the fillers that are used.

The rubber mixtures according to the invention are suitable for the production of rubber vulcanates by corresponding crosslinking reactions with the known crosslinking agents, and are used in the production of molded bodies of any kind, especially in the production of cable sheaths, hoses, drive belts, conveyor belts, roller coverings, tire components, shoe soles, gaskets, damping elements and membranes.

### EXAMPLES

### Preparation of the rubber microgels

### Example 1: Microgel (1)

Microgel (1) is an SBR gel having a styrene content of 24 wt. %. It is used in the rubber mixture according to the present invention in the form of a masterbatch having a content of 50 wt. % NR rubber.

Gel (1) is prepared by after-crosslinking an SBR latex having a styrene content of 24 wt. % (Baystal B L 1357® from Bayer France, Pôrt Jérôme) with 1.5 phr dicumyl peroxide. The crosslinking reaction and working up were carried out according to Example 1 of EP-A 0 854 170. The microgel (1) had a diameter of 60 nm, the swelling index in toluene was 5.

### Example 2: Microgel (2)

Microgel (2) is an SBR gel having a styrene content of 24 wt. % which has been surface-modified with hydroxyethyl methacrylate.

The gel (2) was prepared by reacting or modifying an SBR latex (see gel (1) in this connection) after-crosslinked with 3 phr hydroxyethyl methacrylate (HEMA).

For the modification, the SBR latex (Baystal BL 1357®) after-crosslinked with 1.5 phr dicumyl peroxide was placed in a flask, and the latex was diluted with water so that the solids content of the latex was 20 wt. %. After the addition of 3 phr 97% hydroxymethyl methacrylate, based on the latex solids content, and the addition of 0.12 phr 50% p-methane hydroperoxide, the reaction mixture was heated to 70°C., with stirring, and then stirred at that temperature for one hour. 0.05 wt. %, based on the latex solids content, of an aqueous 0.5 wt. % solution of the sodium salt of 1-hydroxymethanesulfinic acid dihydrate (Rongalit® from BASF) was then added to the mixture in the course of one hour. Throughout the reaction, the pH value was kept constant at pH 9 by the addition of IN sodium hydroxide solution. After a reaction time of one hour at 70° C., the latex had a polymerization conversion of 90%. The density of the latex particles was 0.987 g/cm³. The particle diameters were: d₁₀= 46 nm; d₅₀=52 nm; d₈₀=57 nm.

Before the modified SBR latex was precipitated, the anti-aging agents listed below were additionally stirred into the latex, in each case in the indicated amounts, based on 100 parts by weight of solid:

| | |
|---|---|
| 0.05 phr | 2,2-methylene-bis-(4-methyl-6-cyclohexylphenol) |
| | (Vulkanox ZKF from Bayer AG) |
| 0.22 phr | di-tert-butyl-p-cresol (Vulkanox KB from Bayer AG) |
| 0.38 phr | di-laurylthio dipropionate (PS 800 from Ciba Geigy AG). |

For the precipitation of 5.035 kg of a 19.86% SBR latex modified with hydroxyl groups, 6000 g of water, 795.6 g of sodium chloride and 425 g of precipitating agent (Superfloc® C567 (1%) from American Cyanamide Corporation) were placed in a vessel.

The precipitating agents in the vessel were heated to 60° C. and the pH value was adjusted to 4 using 10 wt. % sulfuric acid. While maintaining that pH value, the modified latex was introduced into the precipitating agent. After the addition of the latex, the mixture was heated to 60° C. and then cooled to about 30° C. by the addition of cold water. The rubber gel obtained thereby was washed several times and, after filtration, dried in vacuo at 70° C. until a constant weight was reached (about 60 hours).

The resulting gel (2) had a gel content of 97 wt. %, the swelling index of the gelled portion being 5.3. The OH number of the resulting gel (2) was 9 mg of KOH per gram of rubber gel, and the glass transition temperature T_{g} was −9.5° C.

### Example 3: Rubber gel (3)

Rubber gel (3) is an SBR gel having a styrene content of 40 wt. %, which has been surface-modified with hydroxyethyl methacrylate.

Gel (3) was prepared starting from oil-free Krylene® 1721 latex from Bayer France (La Wantzenau) by after-crosslinking with 1.0 phr dicumyl peroxide and by subsequent modification with 3 phr hydroxyethyl methacrylate.

Modification of rubber gel (3) with hydroxyethyl methacrylate was carried out analogously to the modification of rubber gel (2) (Example 2).

After the modification, the density of the resulting latex particles was 0.9947 g/cm³. The particle diameters were: d₁₀=37 nm; d₅₀=53 nm; d₈₀ =62 nm. Stabilization, precipitation and drying of the modified rubber gel (3) were likewise carried out analogously to the stabilization, precipitation and drying of gel (2).

The gel content of the isolated rubber gel (3) was 99 wt. %, and the swelling index of the gelled portion was 6.7. The OH number was 7.9 mg of KOH per gram of rubber gel. The glass transition temperature of the gel was −12° C.

### Example 4: Preparation of the rubber mixtures, vulcanization thereof, and the measured physical values of the vulcanates

Mixture series A:

The mixture constituents listed in the following Table 1 (amounts in phr) were mixed on a laboratory roller in the conventional manner.

TABLE 1

| Mixture No. | 1 | 2 | 3 | 4 | 5 | 6 | 7 | 8 | 9 |
|---|---|---|---|---|---|---|---|---|---|
| Masticated | 100 | 50 | 60 | 70 | 80 | 100 | 100 | 100 | 100 |
| natural rubber¹⁾ | | | | | | | | | |
| Unmodified | — | 100 | 80 | 60 | 40 | — | — | — | — |
| SBR gel (batch | | | | | | | | | |
| KA8650/19) | | | | | | | | | |
| Hydroxyl- | — | — | — | — | — | 50 | 40 | 30 | 20 |
| modified SBR | | | | | | | | | |
| gel (OBR 952) | | | | | | | | | |
| Stearic acid | 3.0 | 3.0 | 3.0 | 3.0 | 3.0 | 3.0 | 3.0 | 3.0 | 3.0 |
| Zinc oxide | 3.0 | 3.0 | 3.0 | 3.0 | 3.0 | 3.0 | 3.0 | 3.0 | 3.0 |
| Antioxidant | 1.5 | 1.5 | 1.5 | 1.5 | 1.5 | 1.5 | 1.5 | 1.5 | 1.5 |
| wax²⁾ | | | | | | | | | |
| IPPD³⁾ | 1.0 | 1.0 | 1.0 | 1.0 | 1.0 | 1.0 | 1.0 | 1.0 | 1.0 |
| TMQ⁴⁾ | 1.0 | 1.0 | 1.0 | 1.0 | 1.0 | 1.0 | 1.0 | 1.0 | 1.0 |
| Mineral oil | 3.0 | 3.0 | 3.0 | 3.0 | 3.0 | 3.0 | 3.0 | 3.0 | 3.0 |
| plasticizer⁵⁾ | | | | | | | | | |
| Sulfur | 1.6 | 1.6 | 1.6 | 1.6 | 1.6 | 1.6 | 1.6 | 1.6 | 1.6 |

¹⁾TSR 5, Defo 700
²⁾Mixture of paraffins and microwaxes (Antilux ® 654 from Rheinchemie Rheinau GmbH)
³⁾N-isopropyl-N′-phenyl-p-phenylenediamine (Vulkanox ® 4010 NA from Bayer AG)
⁴⁾2,2,4-Trimethyl-1,2-dihydroquinoline (polym.) (Vulkanox ®HS from Bayer AG)
⁵⁾Enerthene ® 1849-1 from BP Oil GmbH
⁶⁾N-tert-butyl-2-benzthiazylsulfenamide (Vulkacit NZ ® from Bayer AG)
⁷⁾1,3-bis(3-isocyanato-4-methylphenyl)-1,3-diazetidine-2,4-dione (Desmodur TT ® from Rhein Chemie Rheinau GmbH)

The rates of vulcanization of the mixtures were studied in a rheometer experiment at 160° C. The Monsanto rheometer MDR 2000E was used for that purpose. Using those measurements, the following characteristic data were determined: Fₘᵢₙ; Fₘₐₓ₋Fₘᵢₙ; t₁₀; t₈₀ and t₉₀.

TABLE 2

| Mixture | | | | | | | | | |
|---|---|---|---|---|---|---|---|---|---|
| no.: | 1 | 2 | 3 | 4 | 5 | 6 | 7 | 8 | 9 |
| Fₘᵢₙ[dNM] | 0.54 | 1.06 | 0.91 | 0.79 | 0.63 | 1.75 | 1.46 | 0.98 | 0.77 |
| FₘₐₓFₘᵢₙ | 24.2 | 27.01 | 26.14 | 25.53 | 25.12 | 30.95 | 29.69 | 29.67 | 28.77 |
| [dNM] | | | | | | | | | |
| t₁₀ [min.] | 0.74 | 0.61 | 0.63 | 0.66 | 0.70 | 0.36 | 0.39 | 0.40 | 0.45 |
| t₈₀ [min.] | 15.23 | 18.47 | 18.15 | 17.63 | 17.00 | 19.75 | 18.87 | 17.91 | 17.86 |
| t₉₀ [min.] | 17.60 | 21.40 | 21.08 | 20.59 | 19.74 | 23.04 | 21.93 | 20.85 | 20.49 |

The mixtures were vulcanized in a press for 37 minutes at 160° C. The following physical data were determined on the vulcanates:

TABLE 3

| Mixture no.: | 1 | 2 | 3 | 4 | 5 | 6 | 7 | 8 | 9 |
|---|---|---|---|---|---|---|---|---|---|
| Tensile strength | 25.7 | 24.9 | 27.1 | 27.5 | 26.7 | 25.8 | 27.5 | 28.7 | 27.1 |
| (F) [MPa] | | | | | | | | | |
| Ultimate elongation | 635 | 480 | 555 | 570 | 585 | 475 | 510 | 520 | 550 |
| (D) [%] | | | | | | | | | |
| Tensile stress at 100 | 2.0 | 3.1 | 2.8 | 2.6 | 2.4 | 4.6 | 4.0 | 3.6 | 2.8 |
| elongation (S₁₀₀) | | | | | | | | | |
| [MPa] | | | | | | | | | |
| Tensile stress at 100 | 5.0 | 11.5 | 9.7 | 8.4 | 7.2 | 12.5 | 11.4 | 11.0 | 8.4 |
| elongation (S₁₀₀) | | | | | | | | | |
| [MPa] | | | | | | | | | |
| Shore A hardness | 66 | 75 | 73 | 72 | 70 | 78 | 76 | 75 | 73 |
| 23° C. | | | | | | | | | |
| Shore A hardness | 66 | 70 | 69 | 68 | 66 | 73 | 71 | 71 | 69 |
| 70° C. | | | | | | | | | |
| Rebound resilience, | 59 | 42 | 44 | 47 | 51 | 41 | 43 | 46 | 51 |
| 23° C. [%] | | | | | | | | | |
| Rebound resilience, | 66 | 61 | 62 | 63 | 65 | 60 | 62 | 62 | 64 |
| 70° C. [%] | | | | | | | | | |
| 60 emery abrasion | 155 | 138 | 135 | 137 | 139 | 119 | 117 | 125 | 128 |
| [mm³] | | | | | | | | | |
| S₃₀₀ × D | 3.175 | 5.520 | 5.384 | 4.788 | 4.212 | 5.938 | 5.814 | 5.720 | 4.620 |

Result:

Both in vulcanates containing unmodified SBR gel and in vulcanates containing hydroxyl-modified SBR gel, higher hardnesses, higher tensile stresses and lower abrasion values than in the gel-free vulcanates are found when 15 phr of dimeric toluylene diisocyanate are used. The level of the mechanical properties, characterised by the product (S₃₀₀×D), is higher in the case of both the unmodified and the hydroxyl-modified gels than in the case of the gel-free vulcanate.

### Example 5: Mixture series B

The following constituents of the rubber mixture were mixed on a laboratory roller in the order indicated in the Table (amounts are in phr).

TABLE 4

| Mixture no.: | 10 | 11 | 12 | 13 | 14 | 15 | 16 | 17 |
|---|---|---|---|---|---|---|---|---|
| Masticated natural rubber¹⁾ | 100 | 100 | 100 | 100 | 100 | 100 | 100 | 100 |
| Hydroxyl-modified | 40 | 40 | 40 | 40 | 40 | 40 | 40 | 40 |
| SBR gel (OBR 1026) | | | | | | | | |
| Stearic acid | 3 | 3 | 3 | 3 | 3 | 3 | 3 | 3 |
| Zinc oxide | 3 | 3 | 3 | 3 | 3 | 3 | 3 | 3 |
| Antioxidant wax²⁾ | 1.5 | 1.5 | 1.5 | 1.5 | 1.5 | 1.5 | 1.5 | 1.5 |
| IPPD³⁾ | 1 | 1 | 1 | 1 | 1 | 1 | 1 | 1 |
| TMQ⁴⁾ | 1 | 1 | 1 | 1 | 1 | 1 | 1 | 1 |
| Mineral oil plasticizer⁵⁾ | 3 | 3 | 3 | 3 | 3 | 3 | 3 | 3 |
| Sulfur | 1.6 | 1.6 | 1.6 | 1.6 | 1.6 | 1.6 | 1.6 | 1.6 |
| Accelerator TBBS⁶⁾ | 2 | 2 | 2 | 2 | 2 | 2 | 2 | 2 |
| Dimeric toluylene | 5 | 10 | 15 | 20 | 25 | 30 | 35 | 40 |
| diisocyanate⁷⁾ | | | | | | | | |

¹⁾TSR 5, Defo 700
²⁾Mixture of paraffins and microwaxes (Antilux ® 654 from Rheinchemie Rheinau GmbH)
³⁾N-isopropyl-N′-phenyl-p-phenylenediamine (Vulkanox ® 4010 NA from Bayer AG)
⁴⁾2,2,4-Trimethyl-1,2-dihydroquinoline (polym.) (Vulkanox ® HS from Bayer AG)
⁵⁾Enerthene ® 1849-1 from BP Oil GmbH
⁶⁾N-tert-butyl-2-benzthiazylsulfenamide (Vulkacit NZ ®from Bayer AG)
⁷⁾1,3-bis(3-isocyanato-4-methylphenyl)-1,3-diazetidine-2,4-dione (Desmodur TT ® from Rheinchemie Rheinau GmbH)

The rates of vulcanization of the mixtures were studied in a rheometer experiment at 160° C. The Monsanto rheometer MDR 2000E was used for that purpose. Using those measurements, the following characteristic data were determined: Fₘᵢₙ; Fₘₐₓ₋Fₘᵢₙ; t₁₀; t₈₀ and t₉₀.

TABLE 5

| Mixture no.: | 10 | 11 | 12 | 13 | 14 | 15 | 16 | 17 |
|---|---|---|---|---|---|---|---|---|
| Fₘᵢₙ [dNM] | 0.85 | 1.01 | 1.16 | 1.23 | 1.34 | 1.26 | 1.41 | 1.39 |
| FₘₐₓFₘᵢₙ | 8.07 | 12.57 | 21.85 | 24.86 | 22.45 | 16.87 | 13.16 | 11.27 |
| [dNM] | | | | | | | | |
| t₁₀ [min.] | 0.52 | 0.34 | 0.37 | 0.37 | 0.35 | 0.32 | 0.30 | 0.28 |
| t₈₀ [min.] | 11.68 | 15.42 | 14.53 | 17.38 | 17.23 | 16.80 | 18.31 | 20.78 |
| t₉₀ [min.] | 12.88 | 16.62 | 16.69 | 20.69 | 20.05 | 19.46 | 22.50 | 26.42 |

The mixtures were vulcanized in a press at 160° C.:

TABLE 6

| Mixture no.: | 10 | 11 | 12 | 13 | 14 | 15 | 16 | 17 |
|---|---|---|---|---|---|---|---|---|
| Vulcanization time [min.] | 8 | 8 | 8 | 6 | 6 | 6 | 6 | 6 |

The following data were determined on the vulcanates:

TABLE 7

| Mixture no.: | 10 | 11 | 12 | 13 | 14 | 15 | 16 | 17 |
|---|---|---|---|---|---|---|---|---|
| Tensile | 19.9 | 20.9 | 25.1 | 21.6 | 20.9 | 19.5 | 18.9 | 18.4 |
| strength (F) | | | | | | | | |
| [MPa] | | | | | | | | |
| Ultimate | 590 | 555 | 515 | 465 | 495 | 480 | 485 | 490 |
| elongation | | | | | | | | |
| (D) [%] | | | | | | | | |
| Tensile stress | 1.5 | 1.9 | 2.7 | 3.0 | 3.2 | 3.3 | 3.5 | 3.8 |
| at 100% | | | | | | | | |
| elongation | | | | | | | | |
| (S₁₀₀) [MPa] | | | | | | | | |
| Tensile stress | 4.2 | 5.8 | 9.1 | 9.5 | 9.1 | 8.8 | 9.0 | 8.6 |
| at 300% | | | | | | | | |
| elongation | | | | | | | | |
| (S₃₀₀) [MPa] | | | | | | | | |
| Shore A | 52 | 59 | 70 | 73 | 74 | 72 | 72 | 72 |
| hardness, | | | | | | | | |
| 23° C. | | | | | | | | |
| Shore A | 47 | 55 | 65 | 70 | 71 | 70 | 69 | 68 |
| hardness, | | | | | | | | |
| 70° C. | | | | | | | | |
| Rebound | 33 | 31 | 32 | 30 | 30 | 29 | 29 | 28 |
| resilience, | | | | | | | | |
| 23° C. [%] | | | | | | | | |
| Rebound | 70 | 64 | 67 | 64 | 61 | 58 | 55 | 54 |
| resilience, | | | | | | | | |
| 70° C. [%] | | | | | | | | |
| 60 emery | 186 | 146 | 131 | 133 | 136 | 136 | 137 | 144 |
| abrasion | | | | | | | | |
| [mm³] | | | | | | | | |
| S₃₀₀ × D | 2.478 | 3.219 | 4.685 | 4.417 | 4.505 | 4.224 | 4.365 | 4.214 |

Result:

When the amount of dimeric toluylene diisocyanate is varied between 5 phr and 40 phr, an optimum of the product S300×D is found when from 15 to 25 phr are added.

### Example 6: Mixture series C

The following constituents of the rubber mixture were mixed on a laboratory roller in the order indicated in Table 8 (amounts are in phr).

TABLE 8

| Mixture no.: | 18 | 19 | 20 | 21 | 22 | 23 | 24 | 25 |
|---|---|---|---|---|---|---|---|---|
| Masticated | 100 | 100 | 100 | 100 | 100 | 100 | 100 | 100 |
| natural rubber¹⁾ | | | | | | | | |
| Hydroxyl- | 30 | 30 | 30 | 30 | 30 | 30 | 30 | 30 |
| modified SBR | | | | | | | | |
| gel | | | | | | | | |
| (OBR 1031) | | | | | | | | |
| Stearic acid | 3 | 3 | 3 | 3 | 3 | 3 | 3 | 3 |
| Zinc oxide | 3 | 3 | 3 | 3 | 3 | 3 | 3 | 3 |
| Antioxidant | 1.5 | 1.5 | 1.5 | 1.5 | 1.5 | 1.5 | 1.5 | 1.5 |
| wax²⁾ | | | | | | | | |
| IPPD³⁾ | 1 | 1 | 1 | 1 | 1 | 1 | 1 | 1 |
| TMQ⁴⁾ | 1 | 1 | 1 | 1 | 1 | 1 | 1 | 1 |
| Mineral oil | 3 | 3 | 3 | 3 | 3 | 3 | 3 | 3 |
| plasticizer⁵⁾ | | | | | | | | |
| Sulfur | 1.6 | 1.6 | 1.6 | 1.6 | 1.6 | 1.6 | 1.6 | 1.6 |
| Accelerator | 2 | 2 | 2 | 2 | 2 | 2 | 2 | 2 |
| TBBS⁶⁾ | | | | | | | | |
| Trimerized | — | 5 | 10 | 15 | — | — | — | — |
| hexamethylene | | | | | | | | |
| diisocyanate⁷⁾ | | | | | | | | |
| Mixture of | — | — | — | — | 5 | — | — | — |
| dimerized and | | | | | | | | |
| trimerized | | | | | | | | |
| hexamethylene | | | | | | | | |
| diisocyanate⁸⁾ | | | | | | | | |
| Trimerized | — | — | — | — | — | 5 | 10 | 15 |
| hexamethylene | | | | | | | | |
| diisocyanate | | | | | | | | |
| blocked with | | | | | | | | |
| butaneoxime⁹⁾ | | | | | | | | |

¹⁾TSR 5, Defo 700
²⁾Mixture of paraffins and microwaxes (Antilux ® 654 from Rhein Chemie Rheinau GmbH)
³⁾N-isopropyl-N′-phenyl-p-phenylenediamine (Vulkanox ® 4010 NA from Bayer AG)
⁴⁾2,2,4-Trimethyl-1,2-dihydroquinoline (polym.) (Vulkanox ® HS from Bayer AG)
⁵⁾Enerthene ® 1849-1 from BP Oil GmbH
⁶⁾N-tert-butyl-2-benzthiazylsulfenamide (Vulkacit NZ ® from Bayer AG)
⁷⁾Desmodur 3300 ® from Bayer AG
⁸⁾Desmodur 3400 ® from Bayer AG
⁹⁾Desmodur BL 3175 ® from Bayer AG (without solvent)

The rates of vulcanization of the mixtures were studied in a rheometer experiment at 160° C. The Monsanto rheometer MDR 2000E was used for that purpose. Using those measurements, the following characteristic data were determined: Fₘᵢₙ; Fₘₐₓ₋Fₘᵢₙ; t₁₀; t₈₀ and t₉₀.

TABLE 9

| Mixture no.: | 18 | 19 | 20 | 21 | 22 | 23 | 24 | 25 |
|---|---|---|---|---|---|---|---|---|
| Fₘᵢₙ [dNM] | 0.5 | 1.18 | 1.32 | 1.81 | 1.09 | 0.55 | 0.43 | 0.4 |
| FₘₐₓFₘᵢₙ | 10.06 | 9.61 | 9.54 | 9.56 | 9.63 | 10.02 | 10.35 | 10.79 |
| [dNM] | | | | | | | | |
| t₁₀ [min.] | 5.04 | 3.71 | 3.36 | 3.46 | 3.01 | 2.39 | 2.07 | 1.93 |
| t₈₀ [min.] | 7.41 | 6.23 | 5.69 | 6.06 | 5.61 | 4.54 | 4.65 | 5.55 |
| t₉₀ [min.] | 9.03 | 7.55 | 6.79 | 7.06 | 6.7 | 5.59 | 6.09 | 7.9 |

The mixtures were vulcanized in a press at 160° C. in the course of 20 minutes. The following data were determined on the vulcanates:

TABLE 10

| Mixture no.: | 18 | 19 | 20 | 21 | 22 | 23 | 24 | 25 |
|---|---|---|---|---|---|---|---|---|
| Tensile | 26.9 | 27.7 | 24.5 | 21.6 | 26.8 | 25.9 | 24.2 | 21.4 |
| strength (F) | | | | | | | | |
| [MPa] | | | | | | | | |
| Ultimate | 640 | 525 | 455 | 375 | 525 | 635 | 600 | 545 |
| elongation (D) | | | | | | | | |
| [%] | | | | | | | | |
| Tensile stress | 1.3 | 2.1 | 2.2 | 2.5 | 2.3 | 1.6 | 1.9 | 2.2 |
| at 100% | | | | | | | | |
| elongation | | | | | | | | |
| (S₁₀₀) [MPa] | | | | | | | | |
| Tensile stress | 4.1 | 8.3 | 10.6 | 14.2 | 8.3 | 5.2 | 6.2 | 7.3 |
| at 300% | | | | | | | | |
| elongation | | | | | | | | |
| (S₃₀₀) [MPa] | | | | | | | | |
| Shore A hard- | 54 | 61 | 62 | 64 | 60 | 58 | 58 | 59 |
| ness/23° C. | | | | | | | | |
| Shore A hard- | 49 | 53 | 55 | 57 | 53 | 50 | 51 | 51 |
| ness/70° C. | | | | | | | | |
| Rebound resil- | 47 | 47 | 51 | 53 | 47 | 49 | 48 | 49 |
| ience/23° C. | | | | | | | | |
| [%] | | | | | | | | |
| Rebound resil- | 66 | 64 | 65 | 65 | 62 | 66 | 63 | 66 |
| ience/70° C. | | | | | | | | |
| [%] | | | | | | | | |
| 60 emery abra- | 134 | 87 | 77 | 62 | 77 | 109 | 117 | 123 |
| sion [mm³] | | | | | | | | |
| S₃₀₀ × D | 2.624 | 4.358 | 4.823 | 5.325 | 4.358 | 3.302 | 3.720 | 3.979 |

Result:

In comparison with the diisocyanate-free comparison vulcanate, improved mechanical properties (S₃₀₀×D) and lower abrasion values are found both with trimerized diisocyanate and with a mixture of dimerized and trimerized diisocyanate as well as with a trimerized blocked diisocyanate.

### Example 7: Mixture series D

The following constituents of the rubber mixture are mixed on a laboratory roller according to the order indicated in Table 11 (amounts are in phr).

TABLE 11

| Mixture no.: | 26 | 27 | 28 | 29 |
|---|---|---|---|---|
| Masticated natural rubber¹⁾ | 100 | 100 | 100 | 100 |
| Hydroxyl-modified SBR gel (OBR 1031) | 30 | 30 | 30 | 30 |
| Stearic acid | 3 | 3 | 3 | 3 |
| Zinc oxide | 3 | 3 | 3 | 3 |
| Antioxidant wax²⁾ | 1.5 | 1.5 | 1.5 | 1.5 |
| IPPD³⁾ | 1 | 1 | 1 | 1 |
| TMQ⁴⁾ | 1 | 1 | 1 | 1 |
| Mineral oil plasticizer⁵⁾ | 3 | 3 | 3 | 3 |
| Sulfur | 1.6 | 1.6 | 1.6 | 1.6 |
| Accelerator TBBS⁶⁾ | 2 | 2 | 2 | 2 |
| Diphenylmethane 4,4′-diisocyanate (MDI)⁷⁾ | — | 5 | — | — |
| Mixture of approx. 50% MDI and | — | — | 5 | — |
| approx. 50% polymerized MDI⁸⁾ | | | | |
| Mixture of 30% MDI and 70% polymerized | — | — | — | 5 |
| MDI⁹⁾ | | | | |

¹⁾TSR 5, Defo 700
²⁾Mixture of paraffins and microwaxes (Antilux ® 654 from Rhein Chemie Rheinau GmbH)
³⁾N-isopropyl-N′-phenyl-p-phenylenediamine (Vulkanox ® 4010 NA from Bayer AG)
⁴⁾2,2,4-Trimethyl-1,2-dihydroquinoline (polym.) (Vulkanox ® HS from Bayer AG)
⁵⁾Enerthene ® 1849-I from BP Oil GmbH
⁶⁾N-tert-butyl-2-benzthiazylsulfenamide (Vulkacit NZ ® from Bayer AG)
⁷⁾Desmodur N 44M ® from Bayer AG (MDI)
⁸⁾Desmodur N 44 V 20 LF ® from Bayer AG
⁹⁾Desmodur 44 V 40 L ® from Bayer AG

The rates of vulcanization of the mixtures were studied in a rheometer experiment at 160° C. The Monsanto rheometer MDR 2000E was used for that purpose. Using those measurements, the following characteristic data were determined: Fₘᵢₙ; Fₘₐₓ₋Fₘᵢₙ; t₁₀; t₈₀ and t₉₀.

TABLE 12

| Mixture no.: | 26 | 27 | 28 | 29 |
|---|---|---|---|---|
| Fₘᵢₙ [dNM] | 0.5 | 1.28 | 1.61 | 1.50 |
| FₘₐₓFₘᵢₙ [dMA] | 10.06 | 9.64 | 9.33 | 9.31 |
| t₁₀ [mm.] | 5.04 | 6.53 | 8.26 | 8.42 |
| t₈₀ [mm.] | 7.41 | 10.21 | 12.55 | 12.56 |
| t₉₀ [mm.] | 9.03 | 12.30 | 14.07 | 14.07 |

The mixtures were vulcanized in a press at 160° C.:

| Mixture no.: | 26 | 27 | 28 | 29 |
|---|---|---|---|---|
| Vulcanization time [mm.] | 20 | 16 | 24 | 24 |

The following data were determined on the vulcanates:

TABLE 14

| Mixture no.: | 26 | 27 | 28 | 29 |
|---|---|---|---|---|
| Tensile strength (F) [MPa] | 26.9 | 28.4 | 28.2 | 26.6 |
| Ultimate elongation (D) [%] | 640 | 640 | 565 | 530 |
| Tensile stress at 100% elongation | 1.3 | 1.4 | 1.7 | 1.8 |
| (S₁₀₀) [MPa] | | | | |
| Tensile stress at 300% elongation | 4.1 | 5.0 | 7.1 | 7.6 |
| (S₃₀₀) [MPa] | | | | |
| Shore A hardness, 23° C. | 54 | 59 | 55 | 53 |
| Shore A hardness, 70° C. | 49 | 53 | 53 | 54 |
| Rebound resilience, 23° C [%] | 47 | 50 | 52 | 51 |
| Rebound resilience 70° C. [%] | 66 | 67 | 68 | 69 |
| 60 emery abrasion [mm³] | 134 | 103 | 92 | 98 |
| S₃₀₀ × D | 2.624 | 3.200 | 4.012 | 4.028 |

Result:

In comparison with the diisocyanate-free comparison vulcanate, improved mechanical properties (S₃₀₀×D) and lower abrasion values are found both with additions of diphenylmethane 4,4′-diisocyanate (MDI) and with mixtures of monomeric MDI with polymerized MDI.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Rubber mixtures comprising uncrosslinked, double-bond-containing rubbers (A), crosslinked rubber particles (B) and multifunctional isocyanates (C), wherein the amount of component (B) in the mixture is from 1 to 150 parts by weight and the amount of multifunctional isocyanates (C) is from 1 to 100 parts by weight, in each case based on 100 parts by weight (phr) of the rubber component (A).

2. Rubber mixtures according to claim 1, wherein said crosslinked rubber particles (B) are present in from 5 to 100 parts by weight and said multifunctional isocyanates (C) are present in from 3 to 50 parts by weight, in each case based on 100 parts by weight of the rubber component (A).

3. Rubber mixtures according to claim 1, wherein said crosslinked rubber particles (B) have particle diameters of from 5 to 1000 nm and swelling indices in toluene of from 1 to 15.

4. Rubber mixtures according to claim 1, wherein said multifunctional isocyanates (C) contain isocyanates having at least two isocyanate groups in the molecule.

5. Rubber mixtures according to claim 4, wherein said multifunctional isocyanates (C) are selected from the group consisting of hexamethylene diisocyanate, 1-isocyanato-3-(isocyanatomethyl)-3,5,5-trimethylcyclohexane, 2,4- and 2,6-diisocyanatotoluene as well as the corresponding technical isomeric mixture, diphenylmethane diisocyanates, diphenylmethane 4,4′-diisocyanate, diphenylmethane 2,4′-diisocyanate, diphenylmethane 2,2′-diisocyanate as well as the corresponding technical isomeric mixtures, naphthalene 1,5-diisocyanate and 4,4′,4″-triisocyanatotriphenylmethane.

6. Rubber mixtures according to claim 1, wherein said uncrosslinked, double-bond-containing rubbers (A) are selected from the group consisting of natural rubber, styrene/butadiene rubber, polybutadiene rubber, nitrile rubber, butyl rubber, brominated isobutylene/isoprene copolymers having bromine contents of from 0.1 to 10 wt. %, chlorinated isobutylene/isoprene copolymers having chlorine contents of from 0.1 to 10 wt. %, hydrogenated or partially hydrogenated nitrile rubber, styrene/butadiene/acrylonitrile rubber, polychloroprene, epoxidized natural rubber or mixtures thereof, carboxylated nitrile rubbers and carboxylated styrene/butadiene copolymers.

7. Rubber mixtures according to claim 1, wherein said crosslinked rubber particles (B) include those which have been obtained by crosslinking of the following rubbers: polybutadiene, butadiene/acrylic acid C₁₋₄-alkyl ester copolymers, polyisoprene, styrene/butadiene copolymers having styrene contents of from 1 to 60 wt. %, preferably from 5 to 50 wt. %, carboxylated styrene/butadiene copolymers, fluorine rubber, acrylate rubber, polybutadiene/acrylonitrile copolymers having acrylonitrile contents of from 5 to 60 wt. %, carboxylated nitrile rubbers, polychloroprene, isobutylene/isoprene copolymers having isoprene contents of from 0.5 to 10 wt. %, brominated isobutylene/isoprene copolymers having bromine contents of from 0.1 to 10 wt. %, chlorinated isobutylene/isoprene copolymers having chlorine contents of from 0.1 to 10 wt. %, partially and completely hydrogenated nitrile rubbers, ethylene/propylene/diene copolymers, ethylene/acrylate copolymers, ethylene/vinyl acetate copolymers, epichlorohydrin rubbers, silicone rubbers, polyester urethane polymers and polyether urethane polymers.

8. A rubber vulcanate comprising rubber mixtures, which comprise uncrosslinked, double-bond-containing rubbers (A), crosslinked rubber particles (B) and multifunctional isocyanates (C), wherein the amount of component (B) in the mixture is from 1 to 150 parts by weight and the amount of multifunctional isocyanates (C) is from 1 to 100 parts by weight, in each case based on 100 parts by weight (phr) of the rubber component (A).

9. Molded rubber bodies comprising rubber mixtures, which comprise uncrosslinked, double-bond-containing rubbers (A), crosslinked rubber particles (B) and multifunctional isocyanates (C), wherein the amount of component (B) in the mixture is from 1 to 150 parts by weight and the amount of multifunctional isocyanates (C) is from 1 to 100 parts by weight, in each case based on 100 parts by weight (phr) of the rubber component (A).

10. A molded rubber body according to claim 9, wherein said molded rubber body is selected from the group consisting of cable sheaths, hoses, drive belts, conveyor belts, roller coverings, tire components, shoe soles, gaskets, damping elements and membranes.

11. A rubber gel consisting of functional groups that are capable of reacting with isocyanates.

12. A rubber gel according to claim 11, wherein said rubber gel has been functionalized with hydroxyl, carboxyl, amino and/or amide groups.
